(19) United States
(12) Patent Application Publication
(10) Pub. No.: US 2009/0073181 A1
(43) Pub. Date: Mar. 19, 2009

(54) APPARATUS AND METHOD FOR ADJUSTING COLOR OF IMAGES REPRODUCED BY IMAGE REPRODUCING DEVICE

(75) Inventor: Hyung-jin CHOI, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/040,130

(22) Filed: Feb. 29, 2008

(30) Foreign Application Priority Data
Sep. 17, 2007 (KR) 10-2007-0094253

(51) Int. Cl. G09G 5/02; G03F 3/08

(52) U.S. Cl. 345/589; 358/520

(57) ABSTRACT

A method and apparatus for adjusting the color of a reproduction image in an image reproduction device are provided. The color adjusting apparatus for an image reproduction device includes: an average saturation calculation unit calculating the saturation of each color component in an input image signal; a user input unit for a user to input a control signal for color adjustment; an equalization (EQ) generation unit generating graphic equalization (EQ) by referring to the calculated saturation of each color of the average saturation calculation unit and the control signal for color adjustment from the user input unit; an image display unit visually displaying the graphic EQ to the user; and an image signal processing unit converting the input image signal into a reproduction image signal by referring to the control signal for color adjustment from the user input unit.

### CROSS-REFERENCE TO RELATED PATENT APPLICATIONS

This application claims priority from Korean Patent Application No. 10-2007-0094253, filed on Sep. 17, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to an image reproduction device, and more particularly, to adjusting the color of images reproduced in a reproduction image displayed in an image display unit of an image reproduction device.

2. Description of the Related Art

Recently, a variety of image display devices such as a liquid crystal display (LCD) and a plasma display panel (PDP) have been distributed in addition to the conventional cathode ray tube (CRT). At the same time, a variety of types of multimedia content from the conventional television (TV) broadcasting programs to user created contents (UCC) produced by individuals have been explosively increasing, and encoding techniques for these digital contents have also been briskly developed.

For this reason, even identical digital content may have reproduced images with different qualities according to the reproducing devices of the digital content. Also, even when an identical reproduction device is used, the quality of a reproduction image varies depending on the type of digital content being reproduced or encoding method. Accordingly, most reproduction devices provide functions for adjusting the colors of an image so that users can enjoy viewing a reproduction image with a best picture quality or a reproduction image with a picture quality preferred by the user. For example, in order to adjust the picture quality of an image displayed on an LCD monitor of a digital TV according to a user preference, the user can adjust the hue, saturation, contrast, brightness, and sharpness of the image.

Also, according to the conventional color adjustment method, users have to adjust the hue or saturation of an image while watching the change in the picture quality of an image displayed on an image display unit. However, if hues and the like are adjusted only based on the senses of the user, it is impossible to accurately adjust hues and the like.

### SUMMARY OF THE INVENTION

The present invention provides a method and apparatus for accurately and conveniently adjusting colors of a reproduction image in an image reproduction device.

According to an aspect of the present invention, there is provided a color adjusting apparatus for an image reproduction device, the color adjusting apparatus includes: a saturation calculation unit calculating the saturation of each color component in an input image signal; a user input unit inputting a control signal for color adjustment from a user; and an EQ generation unit generating graphic equalization (EQ) by referring to the saturation for each color calculated by the saturation calculation unit and the control signal for color adjustment from the user input unit.

According to another aspect of the present invention, there is provided a method of adjusting a color of an image reproduction device, the method including: displaying graphic EQ for showing an element for each color component of an input image signal on an image display unit; receiving a color adjustment request of a reproduction image signal from a user; and updating the graphic EQ by referring to the color adjustment request.

According to the apparatus and method, changes in colors of an image being reproduced by an image reproduction device are displayed through the graphic EQ, thereby helping the user more accurately and conveniently adjust the color of the reproduction image.

Also, by displaying the graphic EQ on a part of an image display unit, the aesthetic effect of the image reproduction device can be further improved.

### BRIEF DESCRIPTION OF THE DRAWINGS

The above and other features of the present invention will become more apparent by describing in detail exemplary embodiments thereof with reference to the attached drawings in which:

FIG. 1 is a functional block diagram illustrating a color adjusting apparatus for adjusting the color of images reproduced in an image reproduction device, according to an exemplary embodiment of the present invention;

FIG. 2 is a flowchart illustrating a method of adjusting the color of images reproduced in an image reproduction device according to an exemplary embodiment of the present invention;

FIG. 3 is a flowchart illustrating a method of adjusting the color of images reproduced in an image reproduction device according to another exemplary embodiment of the present invention;

FIGS. 4A and 4B are graphs illustrating examples of graphic equalization (EQ) according to an exemplary embodiment of the present invention;

FIGS. 5A and 5B are reference diagrams conceptually explaining a color adjustment request as based on a CT coordinate system, according to an exemplary embodiment of the present invention; and

FIG. 6 is a diagram of an image in which graphic EQ is displayed, according to an exemplary embodiment of the present invention.

### DETAILED DESCRIPTION OF THE INVENTION

The present invention will now be described more fully with reference to the accompanying drawings, in which exemplary embodiments of the invention are shown.

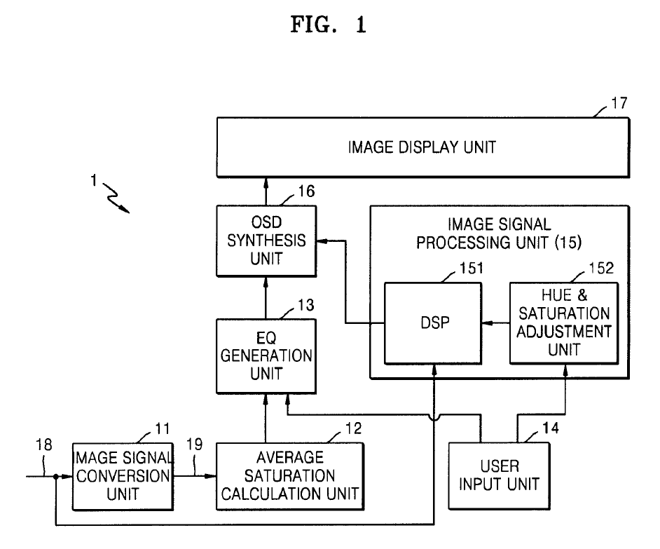

FIG. 1 is a functional block diagram illustrating a color adjusting apparatus 1 for adjusting the color of images reproduced in an image reproduction device, according to an exemplary embodiment of the present invention.

The color adjusting apparatus 1, according to the current embodiment, includes an image signal conversion unit 11, an average saturation calculation unit 12, a graphic equalization (EQ) generation unit 13, a user input unit 14, an image signal processing unit 15, an on-screen display (OSD) synthesis unit 16, and an image display unit 17. The image signal processing unit 15 further includes a digital signal processor (DSP) 151 and a hue/saturation adjustment unit 152.

An input image signal 18, according to the current embodiment, includes a still image or moving pictures formed with a plurality of frames. Also, the input image signal may be any one of a YUV signal, YCbCr signal, and an RGB signal.

The input image signal 18 is converted into a reproduction image signal (for example, R, G, and B color components) by the DSP 151 and then, is transferred to the OSD synthesis unit 16.

According to another exemplary embodiment of the present invention, the DSP 151 may generate an image signal to be reproduced by using a signal 19 that is output from the image signal conversion unit 11, instead of using the input image signal 18.

The image signal conversion unit 11 receives the input image signal 18, and converts the input image signal 18 into any one or more color components of the RGB color space. For example, one or more color components of the RGB color space, red, green, blue, cyan, magenta and yellow (R, G, B, C, M and Y) are selected. Accordingly, if the input image signal 18 is a YUV signal or YCbCr signal, the image signal conversion unit 11 converts the input image signal 18 to obtain the color components R, G, B, C, M and Y, and if the input image signal 18 is an RGB signal, the image signal conversion unit 11 generates the C, M and Y color components by using the input image signal 18, and outputs the resulting signal as a signal 19.

The average saturation calculation unit 12 calculates the average value of saturations of the color components received from the image signal conversion unit 11. That is, the average value of saturations is obtained in units of frames in relation to each of the R, G, B, C, M and Y components.

The EQ generation unit 13 generates graphic equalization by using the average values of saturation of the color components obtained from the average saturation calculation unit 12.

The user input unit 14 is a unit for a user to adjust the hue and/or saturation of a reproduction image. Examples of the user input unit 14 may be a remote controller reception unit, and a control panel attached to an image device. While the user watches graphic EQ displayed on the image display unit 17, the user can make a color adjustment request (or hue and/or saturation adjustment request) of a reproduction image, and then, the user input unit 14 transmits a color adjustment control signal corresponding to the color adjustment request to the hue/saturation adjustment unit 152.

In order to adjust the hue and/or saturation of a reproduction image signal according to the color adjustment control signal received from the user input unit 14, the hue/saturation adjustment unit 152 transmits an adjustment value (or gain) of hue and/or saturation corresponding to the color adjustment control signal, to the DSP 151 as an image signal.

The DSP 151 converts the input image signal into a reproduction image signal appropriate for the image display unit 17 by referring to the adjustment value of hue and/or saturation.

The OSD synthesis unit 16 overlays the reproduction image signal of a frame received from the DSP 151, and the graphic EQ received from the EQ generation unit 13, thereby combining the signals into one image, and transmitting the image to the image display unit 17.

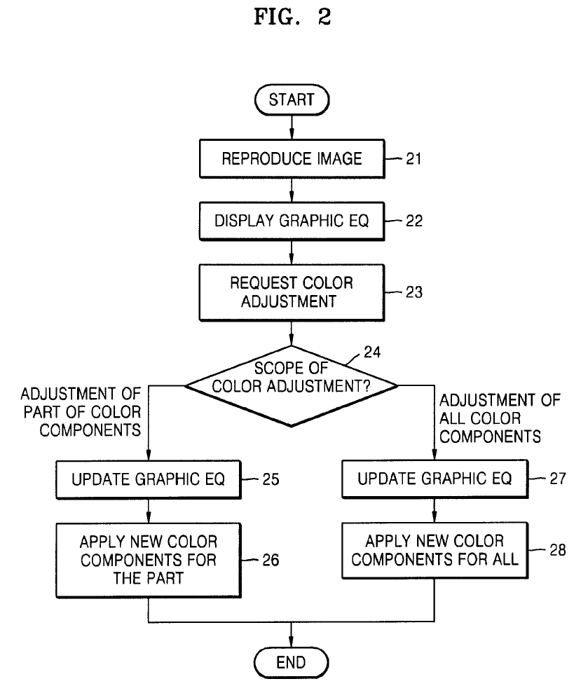

FIG. 2 is a flowchart illustrating a method of adjusting the color of images reproduced in an image reproduction device according to an exemplary embodiment of the present invention.

The method of adjusting the color, according to the current exemplary embodiment, can be performed simultaneously while an image is being reproduced, in operation 21. That is, first, the input image signal 18 is processed in the image signal conversion unit 11, the DSP 151, and the OSD synthesis unit 16, to be displayed on the image display unit 17.

In operation 22, graphic EQ is displayed on the image display unit 17. That is, while the user is watching a reproduction image displayed on the image display unit 17, if the user requests for graphic EQ to be displayed by using a remote controller or the like, the average saturation calculation unit 12 calculates in units of frames an average saturation in relation to each color component signal obtained from the image signal conversion unit 11. The EQ generation unit 13 generates graphic EQ by using the average saturation calculated by the average saturation calculation unit 12.

The thus generated graphic EQ is combined with a reproduction image by the OSD synthesis unit 16 and displayed on the image display unit 17.

Since the average saturation calculation unit 12 calculates the average saturation of the input image signal in units of frames, the graphic EQ displayed on the image display unit 17 is updated in units of frames. Accordingly, the user can observe the saturation (or element) of each color component of the reproduction image in real-time.

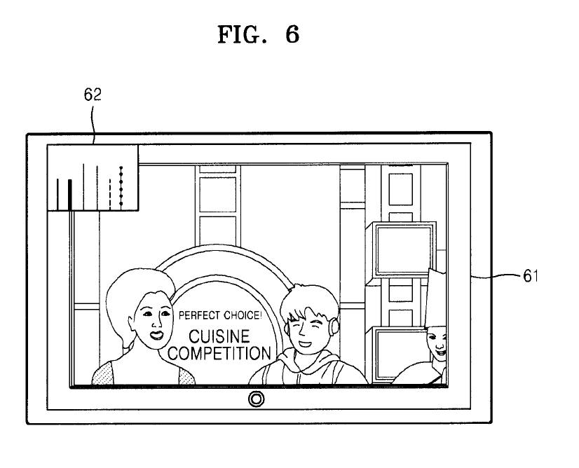

FIG. 6 is a diagram illustrating an image 61 in which graphic EQ 62 is displayed, according to an exemplary embodiment of the present invention.

In operation 23, which is an operation for requesting color adjustment, while the user is watching a reproduction image, if the user decides that color adjustment of the reproduction image is necessary, the user can request for color adjustment by using a remote controller or the like. In this case, the scope (or type) of color adjustment that the user can choose includes partial color component adjustment and all color component adjustment. If the user wants to adjust only part of the color components, such part of the color components that is desired to be adjusted, new hues and saturations of the color components should be input. However, if the user wants to adjust all color components, new hues and saturations, which are desired to be adjusted, should be input.

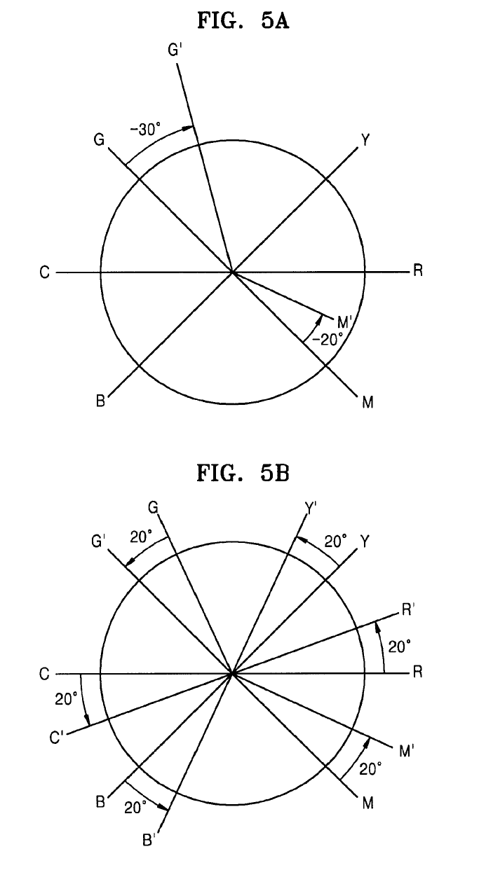

The color adjustment request will be explained conceptually with reference to a CI coordinate system (chrominance circle) illustrated in FIGS. 5A and 5B.

FIGS. 5A and 5B are reference diagrams conceptually explaining the color adjustment request as based on a CI coordinate system, according to an embodiment of the present invention

First, an example in which the user would like to only adjust part of the color components will now be explained. The users may request adjustment of hues and/or saturations of part of the color components R, G, B, C, M and Y, for example, those of the G and M components. The hue can be changed by rotating the phase of the G component by 30 degrees in a clockwise direction, as illustrated in FIG. 5A, and the saturation can be changed by extending the magnitude of the G component in the radiating direction. A new G component G′, after the adjustment, is illustrated in FIG. 5A. Also, in relation to the M component, by rotating the M component by 20 degrees counterclockwise (hue component) and reducing the magnitude (saturation) of the M component, a new M component M′ is obtained.

An example in which the user adjusts all color components at one time will now be explained conceptually. If the user inputs the hues and saturations that are desired to be adjusted, the coordinates of all color components (R, G, B, C, M and Y) are rotated by the same angle in the same direction, and the magnitudes of all the color components are also increased by the same value as illustrated in FIG. 5B. The coordinates of all color components before the adjustment are expressed as R, G, B, C, M and Y, respectively, and the coordinates of all color components after the adjustment are expressed as R′, G′, B′, C′, M′, and Y′, respectively.

If there is a color adjustment request from the user, in operation 23, the color adjustment apparatus 1 determines first the scope (or type) of the color adjustment that the user wants, in operation 24.

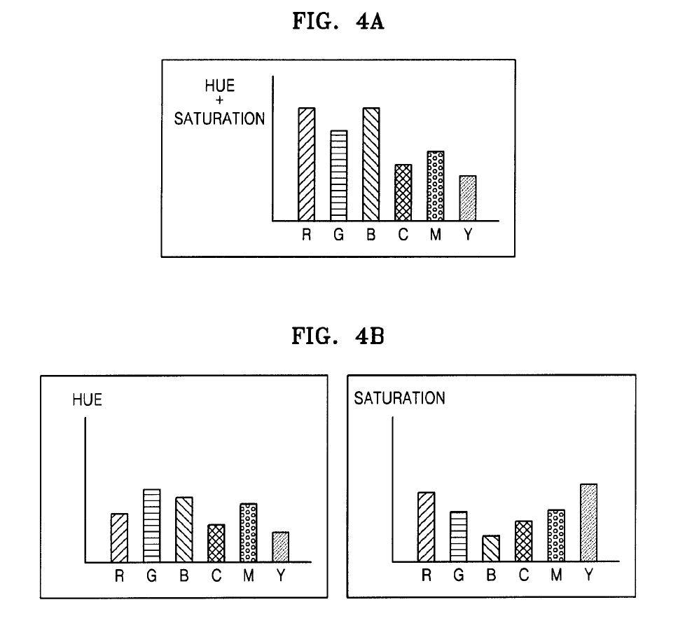

If the determination result, in operation 24, indicates that the user wants adjustment of part of the color components, a color component adjustment control signal, for adjustment of part of the color components in operation 23, is transmitted to the EQ generation unit 13 from the user input unit 14. The EQ generation unit 13 updates graphic EQ by referring to the color component adjustment control signal transmitted in operation 25. That is, the magnitude of the element (hue or saturation) of each component of the graphic EQ illustrated in FIGS. 4A and 4B is changed in proportion to the adjustment value (or gain) of the hue and/or saturation for each color component requested by the user.

FIGS. 4A and 4B are graphs illustrating examples of graphic EQ according to an embodiment of the present invention. The graphic EQ illustrated in FIG. 4A shows the distribution of sums of hues and saturations for each color component (R, G, B, C, M, and Y). In this case, the sum of a hue and saturation may be a simple sum of a hue and saturation value, however, may also be a value obtained by multiplying a hue and saturation value by different weights and then adding the results. Also, the graphic EQ illustrated in FIG. 4B requires two graphs illustrating the magnitudes of the hue and saturation, respectively, of each color component.

In operation 26, the color adjustment request of the user is applied to an image signal to be actually reproduced. That is, the DSP 151 converts the input image signal 18 into a reproduction image signal by applying the adjustment value (or gain) of the hue and/or saturation for each color component received from the hue/saturation adjustment unit 152, and transmits the converted signal to the image display unit 17. By doing so, the user can watch an image of which the colors have been adjusted by the user.

If the determination result, in operation 24, indicates that the user wants adjustment of all color components, the user input unit 14 transmits a color adjustment control signal to the EQ generation unit 13. The EQ generation unit 13 updates graphic EQ by referring to the color adjustment control signal. That is, in proportion to the adjustment value (or gain) of the hue and/or saturation, requested in operation 23, the EQ generation unit 13 adjusts the magnitude of each component the graphic EQ as illustrated in the graphs of FIGS. 4A and 4B, in operation 27.

In operation 28, the color adjustment request of the user is applied to an image signal to be actually reproduced. That is, the DSP 151 converts the input image signal 18 into a reproduction image signal by applying the color adjustment control signal received from the hue/saturation adjustment unit 152, and transmits the converted signal to the image display unit 17. By doing so, the user can watch an image of which the colors have been adjusted by the user.

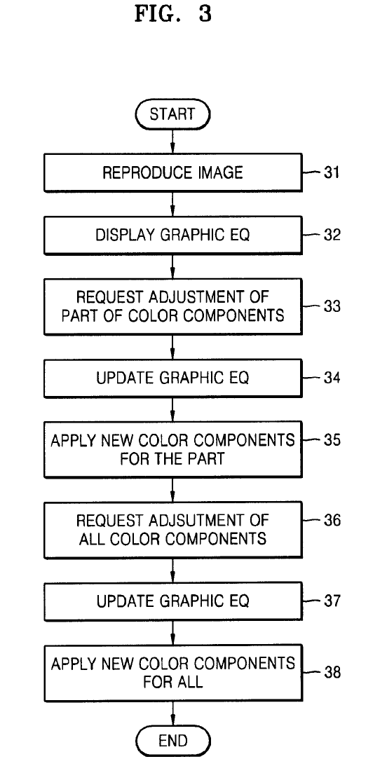

FIG. 3 is a flowchart illustrating a method of adjusting the color of images reproduced in an image reproduction device according to another exemplary embodiment of the present invention.

Each operation of the current embodiment is the same as its corresponding operation illustrated in FIG. 2. However, in the embodiment illustrated in FIG. 2, operations 25 and 26 and operations 27 and 28 are selectively performed, while operations 33 through 35 and operations 36 through 38 illustrated in FIG. 3 are all performed.

In another embodiment of the present invention, the order of performing operations 33 through 35 and operations 36 through 38 illustrated in FIG. 3 may be reversed.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. Other storage media may include carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by one of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for adjusting the color of images reproduced in an image reproduction device comprising:
an average saturation calculation unit which calculates the saturation of each of color components in an input image signal;
a user input unit which receives a user input as a control signal for color adjustment; and
an equalization (EQ) generation unit which generates graphic EQ by referring to the calculated saturation of each of the color components of the average saturation calculation unit and the control signal for color adjustment from the user input unit.

2. The apparatus of claim 1, further comprising an image display unit which visually displays the graphic EQ.

3. The apparatus of claim 2, further comprising an image signal processing unit which converts the input image signal into a reproduction image signal by referring to the control signal for color adjustment from the user input unit.

4. The apparatus of claim 3, wherein the image signal processing unit comprises:
a digital signal processor (DSP) which converts the input image signal into the reproduction image signal; and
an adjustment unit which adjusts at least one of a gain of a hue and a gain of a saturation of the reproduction image signal of the DSP by referring to the control signal for color adjustment.

5. The apparatus of claim 3, further comprising an on-screen display (OSD) synthesis unit which combines the reproduction image signal received from the image signal processing unit and the graphic EQ received from the EQ generation unit into one image.

6. The apparatus of claim 1, wherein the color components comprises at least two of red, green, blue, cyan, magenta and yellow (R, G, B, C, M and Y) color components.

7. The apparatus of claim 6, wherein the control signal for color adjustment adjusts at least one of a hue and a saturation of at least one of the color components.

8. The apparatus of claim 1, wherein the graphic EQ displays at least one of hue and saturation for each of the color components.

9. The apparatus of claim 1, wherein the average saturation calculation unit obtains an average saturation value per frame of an input image signal.

10. The apparatus of claim 1, further comprising an image signal conversion unit which converts the input image signal into a color component in an RGB color space.

11. A method of adjusting the color of images reproduced in an image reproduction device comprising:
displaying graphic equalization (EQ) to show an element for each of color components of an input image signal on an image display unit;
receiving a color adjustment request of a reproduction image signal from a user; and
updating the graphic EQ by referring to the color adjustment request.

12. The method of claim 11, further comprising converting the input image signal into a reproduction image signal by referring to the color adjustment request.

13. The method of claim 11, wherein the color adjustment request adjusts at least one of a hue and a saturation of a part of the color components of the reproduction image signal.

14. The method of claim 11, wherein the color adjustment request adjusts at least one of hues and saturations of all of the color components of the reproduction image signal.

15. The method of claim 11, further comprising determining whether the color adjustment request received from the user requests adjustment of a part or all of the color components.

16. The method of claim 11, wherein the color components of the input image comprises at least two of red, green, blue, cyan, magenta and yellow (R, G, B, C, M and Y) color components.

17. The method of claim 16, wherein the color adjustment request adjusts at least one of a hue and a saturation of a part of the color components.

18. The method of claim 16, wherein the color adjustment request adjusts at least one of hues and saturations of all of the color components.

19. The method of claim 11, wherein the graphic EQ comprises a graph illustrating a magnitude of an element for each of the color components.

20. A computer readable recording medium having encoded thereon a computer program for executing a method of adjusting the color of images reproduced in an image reproduction device, wherein the method comprises:
displaying graphic equalization (EQ) to show an element for each of color components of an input image signal on an image display unit;
receiving a color adjustment request of a reproduction image signal from a user; and
updating the graphic EQ by referring to the color adjustment request.
